(19) United States
(12) Patent Application Publication
(10) Pub. No.: US 2001/0037274 A1
(43) Pub. Date: Nov. 1, 2001

(54) Method of cost effectively funding a loan

(76) Inventor: Douglas Monticciolo, New York, NY (US)

Correspondence Address: STROOCK & STROOCK & LAVAN LLP, 180 Maiden Lane, New York, NY, 10038, US

(21) Appl. No.: 09/805,522

(22) Filed: Mar. 13, 2001

Related U.S. Application Data
(60) Provisional application No. 60/188,729, filed on Mar. 13, 2000.

(51) Int. Cl. G06F 17/60

(52) U.S. Cl. 705/35

(57) ABSTRACT

A method of achieving cost effective funding by providing a financial guaranty in the form of reinsurance to an insurance company to insure the lender's or a third party's loans. The financial guaranty enables the lender (i.e., the originator of the loan) or a third party to retain a first loss on a pool of assets such as, for example, a pool of loans underwritten by the lender or third party. The financial guaranty preferably provides sufficient coverage for loan losses that may occur due default of a loan or a pool of loans and induces an insurer to issue the insurance.

### CROSS-REFERENCE TO RELATED APPLICATION

This patent application claims priority from provisional patent application Ser. No. 60/188,729, filed on Mar. 13, 2000.

### BACKGROUND OF THE INVENTION

1. Field of the Invention

The present invention is directed to a method of cost effectively finding a loan.

2. Background of the Invention

The Internet has simplified many commercial transactions, such as shopping, making travel reservations, trading stocks, and others. The Internet also makes it possible to shop for a loan twenty-four hours a day, seven days a week, with relative ease. Web-sites exist that enable a loan consumer (also referred to herein as a borrower) to enter certain information via a web-page such as, for example, certain personal and financial data, and to simultaneously solicit loan quotes from a plurality of lending institutions (also referred to herein as lenders). That aspect of on-line loan origination is clearly an advantage to the traditional model in which the borrower must separately solicit quotes from the various lending institutions by filling out and submitting the various loan request forms to each of the separate lenders.

In the on-line model described above, responses from the various lending institutions are presented to the borrower as offers which the borrower may accept or reject. If an offer is accepted, the borrower and lending institution revert to a more traditional loan process in which various forms and supporting documentation are required from the borrower.

Underwriting and funding of such on-line loan transactions also follows traditional models, with the lending institution typically mitigating its risk by conducting due diligence on the borrower, taking a security interest in collateral (e.g., real estate, equipment, financial assets, etc.), and through diversification by spreading the risk of loss (such as may occur when a borrower defaults) over numerous loans. The lender may also obtain insurance from a financial guarantor (i.e., an insurance company) for a loan or a pool of loans to mitigate the risk of loss for the lender or other provider of the loan proceeds (e.g., investors).

While this method and system for underwriting loans has traditionally worked, it has its shortcomings. For example, if a lender does not have an adequate credit rating it may be difficult for the lender to obtain insurance from an insurance company, and thus the lender will not be able to access the capital markets. Such a lender would likely have to accumulate a significant amount of product (i.e., loans) and securitize the accumulated product as a fixed pool of assets that may be purchased or invested in by investors. Such a lender also would not likely have access to capital markets as a source of funding for its loans.

### SUMMARY OF THE INVENTION

The present invention overcomes the above-described shortcomings of the prior art. In accordance with embodiments of the present invention, a lender provides a financial guaranty in the form of reinsurance or other like protection to the insurance company as first loss protection and to insure the lender's loans. The reinsurance or other like protection enables a lender to obtain insurance from a rated insurance company. As a result, the lender's loans derive the benefit of the insurance company's rating, and an unrated or inadequately rated lender may obtain a rated pool of assets that is attractive to investors in the capital markets. The financial guaranty thus enables the lender to receive attractive funding through the private placement and capital markets (e.g., through the issuance of commercial paper). The financial guaranty enables the lender (i.e., the originator of the loan) to retain a first loss on a pool of assets such as, for example, a pool of loans underwritten by the lender. The financial guaranty preferably provides sufficient coverage for loan losses that may occur due to default of a loan or a pool of loans.

In an embodiment of the present invention, a lender may originate one or more loans (of virtually any type) to one or more borrowers (of virtually any type). To obtain adequately rated insurance for the one or more loans, the lender may provide first loss protection in the form of reinsurance to the insurance company to minimize the insurance company's exposure due to loan default. By the lender or another entity providing first loss protection for the one or more loans, the insurance company may be enticed to insure the lender's loans. The lender may thus obtain rated insurance for its loan(s) and gain access to the capital markets as a source of funding for its loan(s).

The invention accordingly comprises the features of construction, combination of elements, and arrangement of parts which will be exemplified in the disclosure herein, and the scope of the invention will be indicated in the claims.

### BRIEF DESCRIPTION OF THE DRAWINGS

In the drawing figures, which are not to scale, and which are merely illustrative, and wherein like reference numerals depict like elements throughout the several views:

FIG. 1 is a schematic block diagram depicting the relationship between and among the various parties to a loan in accordance with the present invention; and

FIG. 2 is a schematic block diagram of a lender and borrower communicating over a network in accordance with the present invention.

### DETAILED DESCRIPTION OF THE PREFERRED EMBODIMENTS

The present invention is directed to a method of cost effectively funding a loan. In accordance with embodiments of the present invention, a novel form of funding commercial loans is provided whereby the lender provides reinsurance or other like protection to an insurer of the lender's loans as first loss protection for the loans originated by the lender. Provision of reinsurance by the lender induces the insurer to issue the insurance.

The inventive method may be carried out in connection with a computer connectable to a network such as, for example, LAN, WAN, intranet, Internet (including the World-Wide Web), cellular, etc. As used herein, the term “computer” is intended to be construed broadly, and in a non-limiting manner, and to include, without limitation and by way of illustration only, any electronic device capable of receiving input, processing, storing and providing output, typically as digital data. A computer may be a computer of any style, size, and configuration including, without limitation, a server, workstation, desktop, laptop, Internet appliance, notebook, personal digital assistant (PDA), etc. A computer typically includes the following components: a central processing unit (CPU or processor) operable in connection with software, permanent memory (e.g., hard-disk drive, ROM), temporary memory (e.g., RAM), an input device (e.g., keyboard, mouse, trackball, etc.), an output device (e.g., display), and I/O device (e.g., modem). It is known to persons skilled in the art that a computer may comprise some or all of those components, in addition to components not listed.

A “borrower”, as the term is used herein, may be any type of borrower including, by way of non-limiting example, an individual, small business, or any entity desiring to borrow money for whatever reason. Similarly, a “lender”, as the term is used herein, may be any entity in the business of loaning money. In addition, the term “loan” is not intended to refer to a particular type of loan, and is thus used herein in a broad, non-limiting manner and is intended to be interpreted in that way. Those terms (and others) are intended to be interpreted broadly herein, and are not intended to define or otherwise limit the scope of the present invention.

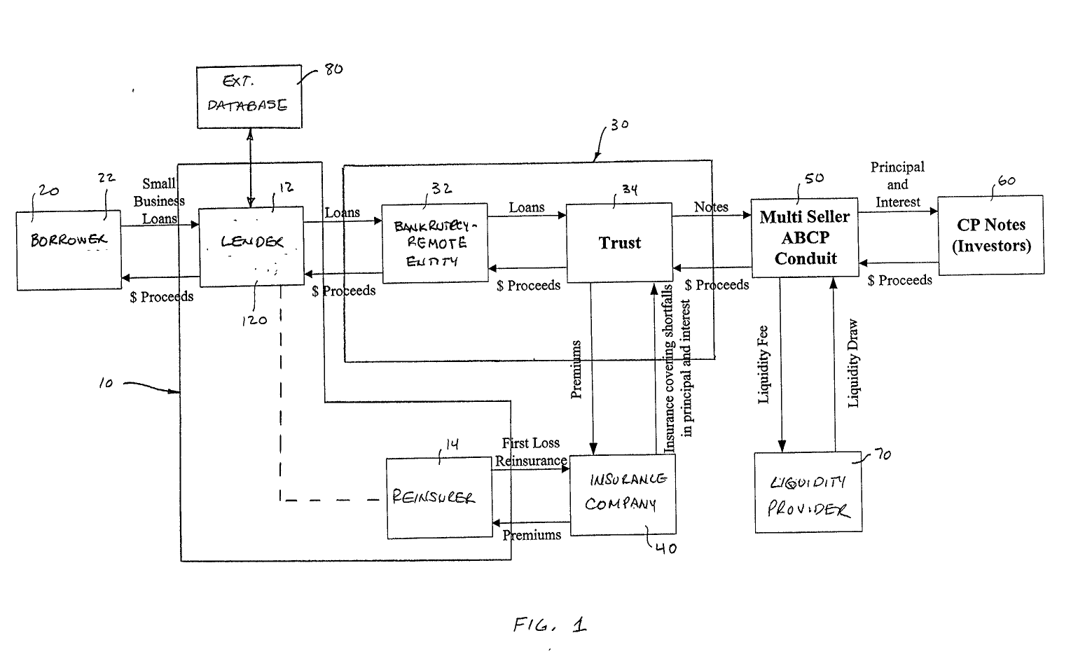

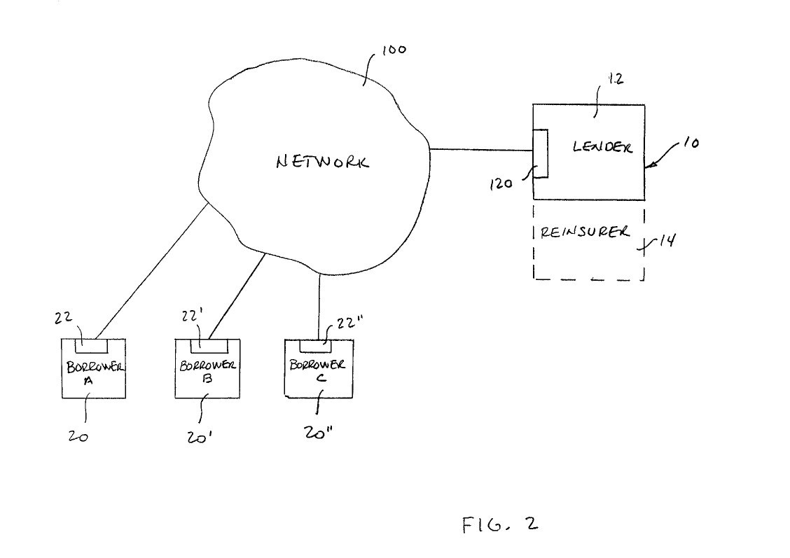

Referring now to the drawings, FIG. 1 depicts the relationship between and among the various parties to a loan origination, funding, maintenance and insurance, and FIG. 2 is a schematic block diagram of a lender and borrower communicating over a network in accordance with the present invention. While the present invention and the description thereof provided herein preferably utilizes computers connectable to a network (i.e., on-line loan transactions), the present invention may also utilize more traditional means of loan origination such as in person processing, telephonic processing, or the like.

With continued reference to FIGS. 1 and 2, the loan process, as described herein, typically begins (originates) when a borrower 20 having a computer 22 connectable to a network 100 requests a loan quotation from a lending institution 10 having a computer 120 connectable to the network 100. The lending institution 10 may comprise a lender 12 and a reinsurer 14. While the lender 12 and reinsurer 14 are disclosed herein as both being part of the lending institution 10, they may also comprise separate entities. The lending process may alternatively begin when a lender 12 makes a loan offer to a borrower 20. During that origination process, the borrower 20 may indicate certain desired features of the loan such as, for example, term, points payable at closing, loan amount, and type of loan. The lender 12 may also dictate similar features of the loan as well as interest rate. In addition, the lender 12 typically requires that the borrower 20 provide certain personal and financial information to enable the lender 12 to evaluate the credit worthiness (i.e., the credit risk) of the borrower 20. All of the above-described information, and other information known to a person of skill in the art, may be communicated between the lender 12 and borrower 20 via computers (each of the lender 12 and borrower 20 having a computer as depicted in FIG. 2), via the telephone, in-person, or any combination of the foregoing. In a preferred embodiment, the lender 12 and borrower 20, using a computer 22, will access a website provided by the lender's computer 120 (or provided on a computer (server) maintained for or on behalf of the lender 12), fill in certain on-line forms, and transmit the information provided via the on-line forms to the lender's computer 120. For example, the lender 12 may require the borrower's age, tax identification number, social security number of the majority shareholder of a company (this example being given by way of small business loans), the loan size, and the industry. Other information may be requested of the borrower 20, as a routine matter of design choice, it being obvious to persons skilled in the art and from the disclosure provided herein the credit risk of any particular borrower 20 may only be sufficiently determined if certain information is provided by the borrower 20 to the lender 12. Moreover, a lender 12 may be required (by its insurer, a regulatory agency, or other third party) to elicit certain information prior to approving a loan. In any case, the information provided by the borrower 20 is communicated from the borrower 20 (the borrower's computer 22) to the lender's computer 120 over the network 100. Preferably, software provided on the lender's computer 120 confirms the veracity of the information received from the borrower 20 and obtains further information about borrower 20 from external databases 80 such as credit bureaus, judgment rolls of various courts and the like. Lender 12 (i.e., lender's computer 120) may compare the various information obtained about the borrower 20 with certain predetermined criteria. That analysis provides an initial determination as to the amount of risk associated with the loan. If the result of the analysis falls out of bounds of the predetermined criteria, then the risk may be too great and lender 12 will send a rejection response to borrower 20 or may refer borrower 20 to another lender.

The lender's computer 120 preferably includes a processor and software operable in connection therewith for, by way of example and not limitation, receiving information from the borrower 20 for a loan request, determining a credit risk of the borrower 20 from the information received, and approving or rejecting the loan request based on the determined credit risk.

If the risk is determined to be within the predetermined criteria, then borrower 20 may be given a contingent approval by telephone, over the Internet by way of e-mail, by an indication at the website of lender 12 or by regular mail or overnight courier.

Once the borrower 20 has selected a loan and the loan has been approved by the lender 12, lender 12 then conducts a more in-depth due diligence by first providing an application to borrower 20. Again, this can be done on-line or by mail, or in person. In this example, in which an application is provided on-line and automatically filled out with all information previously filled out by borrower or gathered from external databases 80, the application itself may be keyed to the particular industry and loan program selected. Borrower 20 can then either download the application and print the application out to fill out manually and then submit to lender 12, or borrower 20 can fill out the application on-line. The application will include more detailed request for assets, potential collateral for the loan, questions about the particular company for which the loan will be granted and the like. Once completed, the application is transmitted either on-line, by e-mail, in person, by a surrogate such as a lawyer or an accountant, by facsimile, by mail, by phone or by overnight courier.

Lender 12 then again confirms the accuracy of the information provided in the application by checking external databases 80, for example. If there is a discrepancy, the application may be returned with a question regarding the discrepancy in real time on-line to borrower 20. It should be noted that the depth of due diligence is a function of the loan program. As a matter of necessity, the shorter the closing date of a particular loan program, the less depth is provided for the due diligence and therefore a higher interest rate is usually applied. Accordingly, the longer the closing period, the more due diligence can be conducted which potentially reduces the risk of the loan and lowers the interest rate.

In a preferred embodiment, the due diligence investigation may include, by way of non-limiting example: bank and trade references; customer and other investigations; lien and litigation searches; product and market surveys; appraisals of assets when taken as collateral security; financial statement analysis to include an assessment of financial condition, profit or loss, cash flow, debt service ability, asset quality, working capital adequacy, and off-balance sheet exposure and other liabilities listed in the footnotes; financial projections analysis; any analyst recommendation; identification of repayment sources; strengths and weaknesses; an analysis of the borrower's industry and management; where applicable, guarantor analysis to include evaluation of contingent debt and other off-balance sheet items; documentation and exception report overviews; and a summary of any lender management and/or site visit.

Once the lender 12 and borrower 20 have come to terms regarding all aspects of the loan, the lender 12 may provide the proceeds of the loan to the borrower 20 via a warehouse line of credit, for example, or alternatively, a third party may provide the proceeds to the lender 12 for pass-through to the borrower 20 or through certificates of deposit and/or Federal Home Loan Bank advances. It is also possible for a lender 12 to purchase an existing loan or pool of loans, using and benefiting from the funding methodology described herein.

It is also possible that a lender 12 not be rated and its loans not be rated making it difficult and expensive to secure investors and insurance. In accordance with the present invention, the lender 12 transfers its loan (the term “loan” also referring to a pool of loans) to an entity 30 comprised of a bankruptcy-remote entity 32 (such an entity being known to persons of skill in the art and being established by following certain requirements and satisfying certain criteria regarding the entity structure) and a trust 34. In that way, the loan is now shielded from the creditors of the lender 12, and becomes a more desirable financial instrument for potential investors.

The bankruptcy-remote entity 32 may pledge or sell the loan to the trust 34 which may be a bank, trust company, or the like, and which holds the loan assets on behalf of and issues notes to investors 60 (discussed in more detail below), collects proceeds from investors 60 and passes them through to the lender 12 (via the bankruptcy-remote entity 32), and obtains insurance on a note issued by the trust 34 to an asset-based commercial paper (ABCP) conduit 50, for example. The ABCP conduit 50 may be a bank or other financial institution that issues commercial paper, notes or other debt instruments to investors 60 (e.g., mutual funds). For example, the note is sold to the ABCP conduit 50 that issues commercial paper to investors 60 in order to fund the loans. Through this process, the lender is able to achieve a more cost effective source of funds for each loan. The trust 34 will pay a premium on outstanding loan amounts to a financial guarantor 40 (e.g., an insurance company or insurer) for the insurance on the note.

A liquidity provider 70 covers any discontinuity of payments from the borrower 20 to the ABCP portal 50.

A reinsurer 14, which may be affiliated with the lender 12 (i.e., part of the lending institution 10), or may be a third party, provides first loss reinsurance protection to the insurer 40 for losses on a predetermined percentage of total loans originated for a predetermined period. As used herein, the term “first loss protection” refers to the reinsurer 14 satisfying any payment obligations (up to a predetermined amount) caused by or as a result of borrower default. For example, the reinsurer 14 may provide first loss reinsurance for losses on 2% of the total loan amount originated for each year until the loan pool matures. The insurer 40 will pay the reinsurer 14 a predetermined amount on outstanding loans per annum for the reinsurance protection. Both the insurance and reinsurance policies will remain in force for the entire life of the loan pool. In a preferred embodiment, the reinsurer 14 is the lender 12, an affiliate of the lender 12, or otherwise associated with the lender in some manner. Thus, the present invention provides a novel form of funding commercial loans by providing, by the lender, reinsurance as a first loss position for the loans originated by the lender and assuring that the lender will have access to more cost effective funding.

In the case where the reinsurer 14 is part of the lending institution 10, the reinsurer may provide reinsurance for the lender's loans, and/or for a third party's loans.

As discussed above, loans are only accepted based upon a complete due diligence of potential borrowers as matched against loan programs and as performed by the lender 12. The insurer 40 may utilize the same due diligence or provide its own criteria to determine the risk allotted with each loan and set premiums accordingly. In a preferred embodiment, the insurer 40 may access a database maintained on the lender's computer 120; the database having stored therein all pertinent information about borrowers and loans. The insurer 40 may thus monitor the activities of the lender 12. Since the insurer 40 is rated, the notes it insures are also rated (i.e., the insurer's rating inures to the benefit of the notes it insures). Thus, what began as an unrated loan by an unrated lender 12 has become a rated note and a desirable investment instrument.

The insurer 40 will charge premiums to the trust 34 and issue an insurance policy for a potential block of loans; although the pricing may be in terms specific to each loan. The premium to be paid is based on each loan. There may be two types of policies in place, a first type of policy may be automatically issued by insurer 40 upon payment of the premium if the risk allotted by insurer 40 or lender 12 falls within a predetermined range. If the risk value does not fall within a predetermined range, then an insurance policy could still be issued against that loan at a different premium with the approval of insurer 40.

For each loan, insurer 40 may quote a premium cost to the trust 34, with that premium being added to the cost of funds and passed on to borrower 20. The beneficiary of the insurance policy is the ABCP conduit 50, and in turn, the investors 60, who be paid the proceeds of the insurance upon the default of any loan.

Administration of the loan after closing may be by the lender 12 or a third party servicer (not shown), if in fact lender 12 has subcontracted servicing of the loans to a third party. In either case, payments by the borrower 20 pass through the servicer (not shown), trust 34, ABCP conduit 50, and to the investors 60. If the borrower defaults, the reinsurer 14 provides a first loss position to ensure that the investors 60 are paid. That first loss position of the reinsurer 14 may only provide insurance to a predetermined amount, which may be the amount of the loan pool, or a lesser amount, as a matter of design choice. The insurer 40 will cover any losses not covered by the reinsurer 14. Premiums for the insurer 40 are paid by the trust 34, and for the reinsurer 14 by the insurer 40.

Thus, while there have been shown and described and pointed out fundamental novel features of the invention as applied to preferred embodiments thereof, it will be understood that various omissions and substitutions and changes in the form and details of the disclosed invention may be made by those skilled in the art without departing from the spirit of the invention. It is the intention, therefore, to be limited only as indicated by the scope of the claims appended hereto.

What is claimed is:

1. A method of cost effectively funding a loan, said method comprising the step of providing, by a lending institution, a financial guaranty to an insurance company as a first loss protection for the loan as an enticement to the insurance company to insure the loan.

2. A method as recited by claim 1, wherein the lending institution comprises a lender and a reinsurer, and wherein the financial guaranty is reinsurance provided by the reinsurer, and wherein the loan is a loan of the lender.

3. A method as recited by claim 1, wherein the lending institution comprises a lender and a reinsurers and wherein the financial guaranty is reinsurance provided by the reinsurer, and wherein the loan is a loan of a third party.

4. A method as recited by claim 1, wherein the loan comprises a pool of loans.

5. A method as recited by claim 1, wherein the loan is transferred by the lending institution to an entity that issues a note to obtain funding for the loan, and wherein the note is insured by the insurance company.

6. A method as recited by claim 5, wherein the entity comprises a bankriuptcy-remote entity and a trust.

7. A method as recited by claim 5, wherein the lending institution comprises a lender and a reinsurer, and wherein the financial guaranty is reinsurance provided by the reinsurer, and wherein the loan is a loan of the lender.

8. A method as recited by claim 5, wherein the lending institution comprises a lender and a reinsurer, and wherein the financial guaranty is reinsurance provided by the reinsurer, and wherein the loan is a loan of a third party.

9. A method of cost effectively funding a loan, said method comprising the steps, by a lending institution, of:
(a) providing a computer connectable to a network and having a processor operable in connection with software for:
receiving information from a borrower for a loan request;
determining a credit risk of the borrower from the information received;
approving or rejecting the loan request based on the determined credit risk;
(b) transferring the loan to an entity that issues a note to obtain funding for the loan, the note being insured by another entity; and
(c) providing a financial guaranty to the another entity for the note.

10. A method as recited by claim 9, wherein the lending institution comprises a lender and a reinsurer, and wherein the financial guaranty is reinsurance provided by the reinsurer, and wherein the another entity is an insurance company, and wherein the loan is a loan of the lender.

11. A method as recited by claim 9, wherein the lending institution comprises a lender and a reinsurer, and wherein the financial guaranty is reinsurance provided by the reinsurer, and wherein the another entity is an insurance company, and wherein the loan is a loan of a third party.

12. A method as recited by claim 9, wherein the entity comprises a bankruptcy-remote entity and a trust.

13. A method as recited by claim 8, wherein the another entity is an insurance company.
